(19) United States
(12) Patent Application Publication
(10) Pub. No.: US 2016/0032991 A1
(43) Pub. Date: Feb. 4, 2016

(54) MOBILE BRAKE DEVICE

(71) Applicant: SIEMENS AKTIENGESELLSCHAFT, München (DE)

(72) Inventors: JÜRGEN NIESTEGGE, Bocholt (DE); KAROLINE EIDNER, Penig (DE)

(73) Assignee: SIEMENS AKTIENGESELLSCHAFT, 80333 München (DE)

(21) Appl. No.: 14/776,117

(22) PCT Filed: Feb. 21, 2014
(86) PCT No.: PCT/EP2014/053380

§ 371 Date: Sep. 14, 2015

(30) Foreign Application Priority Data
Mar. 15, 2013 (DE) 10 2013 204 596.4
Jul. 17, 2013 (EP) 13176880.6

(51) Int. Cl. F16D 55/224

(52) U.S. Cl. CPC F16D 55/2245; F16D 2055/0016

(57) ABSTRACT

A transmission or geared motor includes a mobile brake device which has a brake caliper provided with at least one friction lining on a caliper head of the brake caliper and an adjusting element on a caliper handle of the brake caliper. The friction surface can be moved by adjusting the adjusting element. The mobile brake device further includes a mounting device for detachably mounting the brake caliper on the transmission or the geared motor. The brake device is detachably mounted on the transmission or the geared motor, and the friction lining can be pressed against a brake disk of the transmission or the geared motor when the adjusting element is actuated. The brake disk is connected for conjoint rotation to a shaft of the transmission or the geared motor.

The invention relates to a mobile brake device.

EP 2 410 197 A1 (HANSEN INDUSTRIAL TRANSMISSIONS) 25 Jan. 2012 describes a braking system for an industrial transmission. The braking system comprises two hydraulic brake cylinders which can be mounted on a lantern of the transmission. In this situation a clutch arranged in the lantern is used as the braking body, where brake shoes moved by the brake cylinders are pressed against coupling packs of the coupling. A disadvantage of said braking system is the fact that the braking torque achievable therewith is relatively low and the coupling packs can become thermally overloaded.

The object of the present invention is to provide an improved braking method for a drive component.

This object is achieved by a mobile brake device according to claim 1. The object is further achieved by an application according to claim 6. Preferred developments of the invention are set down in the dependent claims.

The mobile brake device according to the invention comprises a brake caliper which has at least one friction lining on a caliper head of the brake caliper and an adjusting element, in particular a bolt or an hydraulic cylinder, on a caliper handle of the brake caliper, wherein the friction surface can be moved by adjusting the adjusting element, and a mounting device, in particular a bracket, for detachably mounting the brake caliper on a drive component. The application according to the invention of a mobile brake device for braking and holding a shaft of a drive component comprises: firstly the mobile brake device is detachably mounted by means of the mounting device on a part of the drive component fixed in relation to the shaft, such that the friction lining is positioned on one side of a brake disk connected for conjoint rotation to a shaft of the drive component; then the adjusting element is adjusted such that the friction lining is pressed against the brake disk; the brake disk and the shaft connected thereto are held against rotation for a certain period of time by means of the brake caliper; then the adjusting element is adjusted such that the friction lining is released again from the brake disk; and finally the mobile brake device is dismounted again from the drive component.

The present brake device represents a particularly cost-effective and robust solution because it is constructed very simply in mechanical terms. Furthermore, a single brake device is sufficient irrespective of the number of drive components to be braked: for maintenance work on a plurality of drive components the brake device is mounted on each drive component in succession, said drive component is braked and held, and on completion of the maintenance of said braked drive component the brake device is dismounted again. Thereafter these steps are repeated on the next drive component.

Each component of a drive train is understood as being a “drive component”. A drive component can for example be a motor, in particular an electric motor, a transmission, a geared motor, generally any component having a rotating shaft.

A preferred application of the brake is to be found in the technical field of air-cooled condensers, “LUKO” for short in German. The present brake device is advantageously employed in the case of air-cooled condenser installations having a plurality of fans. Air-cooled condensers are used in order to cool cooling media which serve for example to dissipate heat from turbines in power stations. An air-cooled condenser installation may consist of up to approximately one hundred cells which are often arranged in a chequerboard pattern. Each cell is equipped with a drive, for example a geared motor or a motor/coupling/transmission unit for driving a fan (ventilator). Air is drawn in from below by the fan and then blown through a heat exchanger arranged above the fan, thereby generating a cooling effect. On account of heat in the heat exchangers, a natural wind flow in the installation (air-cooled condensers) can be produced as a result of thermals occurring. This situation creates a so-called “windmilling” effect, in other words the fan turns of its own accord even though the drive provided for driving the fan is switched off. For maintenance work it is necessary in such a case to stop said automatically occurring rotation of the fan impeller.

Hitherto fans have in practice often been held by roping with a lasso; this is however an unsatisfactory solution with regard to the aspect of occupational safety. Operators of air-cooled condenser installations require a cost-effective solution which offers the capability to safely brake and to hold a rotating fan in order to allow maintenance to be carried out on the fan impeller. For this purpose the invention offers a mobile brake which makes it possible in each case to bring one fan to a standstill and to lock said fan during operation of the entire air-cooled condenser installation whilst adhering to high safety standards. An advantage of the mobile brake device according to the invention is thus the fact that it can be mounted without risk while a drive installation is operating, in other words with drive components rotating. Safety is thereby increased.

Since as a general rule an air-cooled condenser installation comprises a plurality of drives each having at least one drive train, the advantage of a mobile brake is that only one mobile brake is required for all the drives. In the case of a permanently fitted brake, each brake would need to be provided with a proximity switch for safety reasons in order to exclude the possibility of any impact against the brake. In addition to the increased costs for the actual brake, there would also be additional associated costs for the additional electrical equipment and wiring. The mobile brake according to the invention on the other hand is fitted only in the event of maintenance.

The mobile brake can on the one hand be actuated by means of a hand wheel, in other words the braking operation is activated mechanically by turning the hand wheel by way of a threaded bolt. Alternatively, a mobile hydraulic system, for example a pressure cylinder, can be provided for adjustment of the brake shoes.

It is possible that the friction linings on the caliper head are pivotably mounted; in this manner the full area of the friction surface of the friction linings can optimally be applied to the brake disk during the braking operation. This then also ensures a reliable braking operation if the brake caliper is not positioned centrally with respect to the brake disk on account of tolerances. It is possible that the pivot-mounted friction linings are held in a home position by means of a return spring. The return spring enables the friction linings to be pivoted from the home position but ensures that after the braking operation the brake linings pivot back again into the contactless home position on release of the brake caliper.

According to a preferred development of the invention the brake device is suitable for mobile, in other words releasable, mounting on a lantern, for example a motor lantern, of a transmission or geared motor. This can take place with the aid of threaded bolts which are attached to the lantern and taken through through-holes in the mounting device or by means of bolts which are fixedly mounted on the brake device and introduced into through-holes in the lantern.

After the bolts have been introduced, the brake device is fixedly connected to the lantern by means of bolts for the duration of the mounted period.

According to a preferred development of the invention the mounting device is a brake carrier which has through-holes for accepting guide bolts or fixedly mounted guide bolts for insertion into the through-holes of the lantern and an opening for mounting the brake caliper. Depending on the position of the installed brake disk and arrangement of the lantern, the opening can be arranged in the central region of the brake carrier. A second section of the brake caliper, comprising the brake linings, preferably projects through the opening to a brake disk, while a first section is positioned with the adjusting element in front of the opening. The brake carrier preferably has four holes or bolts arranged in a square or rectangular fashion for accepting bolts or insertion into through-holes.

A preferred development of the invention is a drive component, in particular a transmission/geared motor, having a mobile brake device as described above, wherein the brake device is detachably mounted on the drive component and the friction surfaces of the two brake linings are pressed onto a brake disk of the drive component when the adjusting device is actuated. In this situation the brake disk is connected for conjoint rotation to a shaft or a coupling of the transmission.

The brake carrier can have elongated holes which means that the position of the brake caliper can be adjusted in the axial direction of the brake disk.

The invention will be described in the following with reference to a plurality of exemplary embodiments with the aid of the attached drawing. In the drawings, in each case schematically and not to scale,

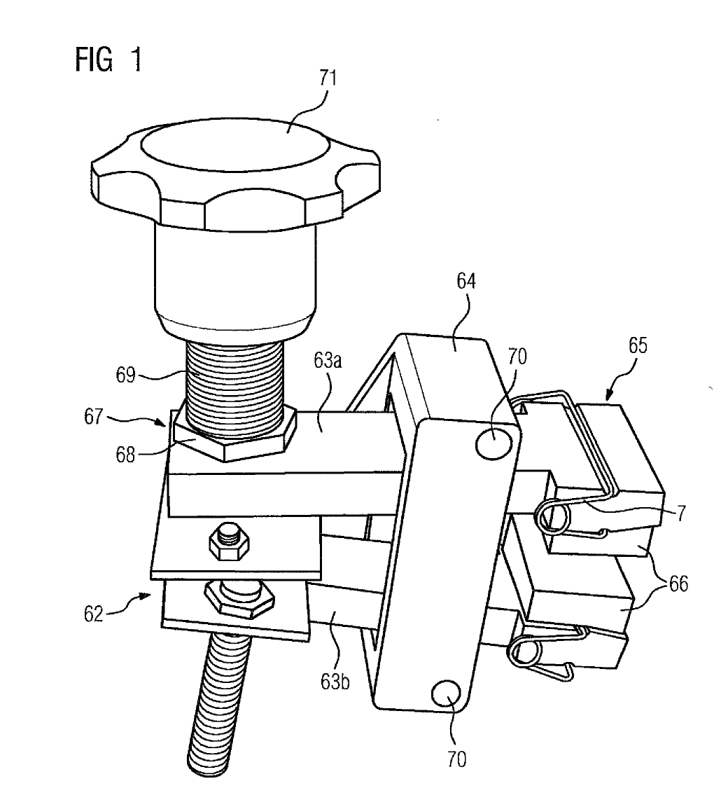

FIG. 1 shows a brake caliper of a brake device;

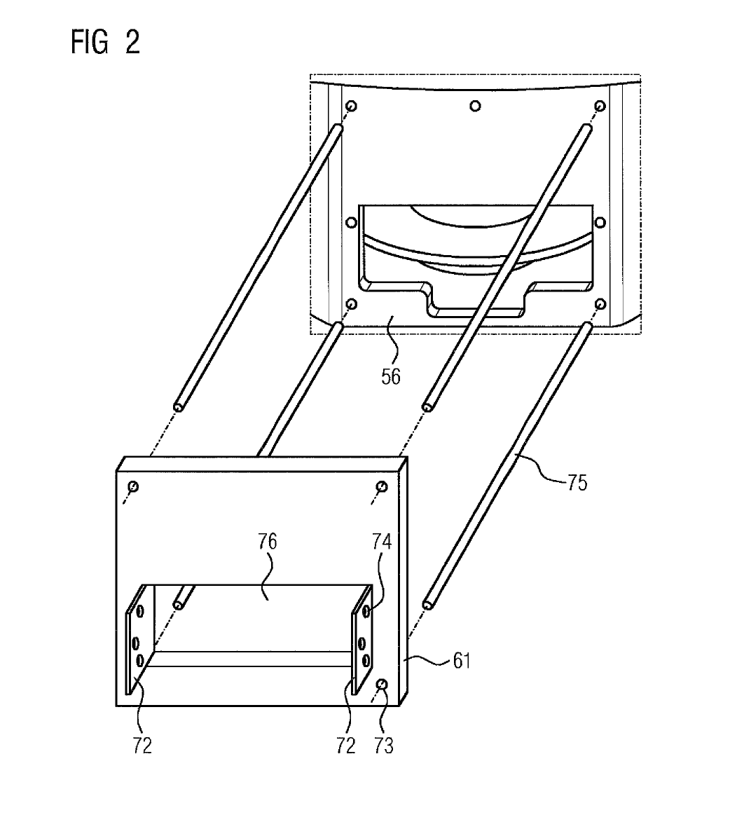

FIG. 2 shows a brake carrier;

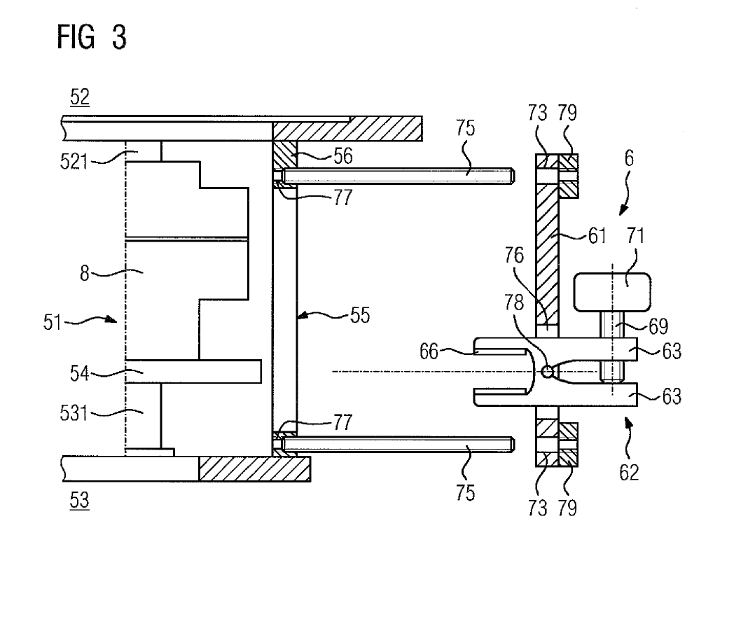

FIG. 3 shows a sectional view of a drive unit and a mobile brake device;

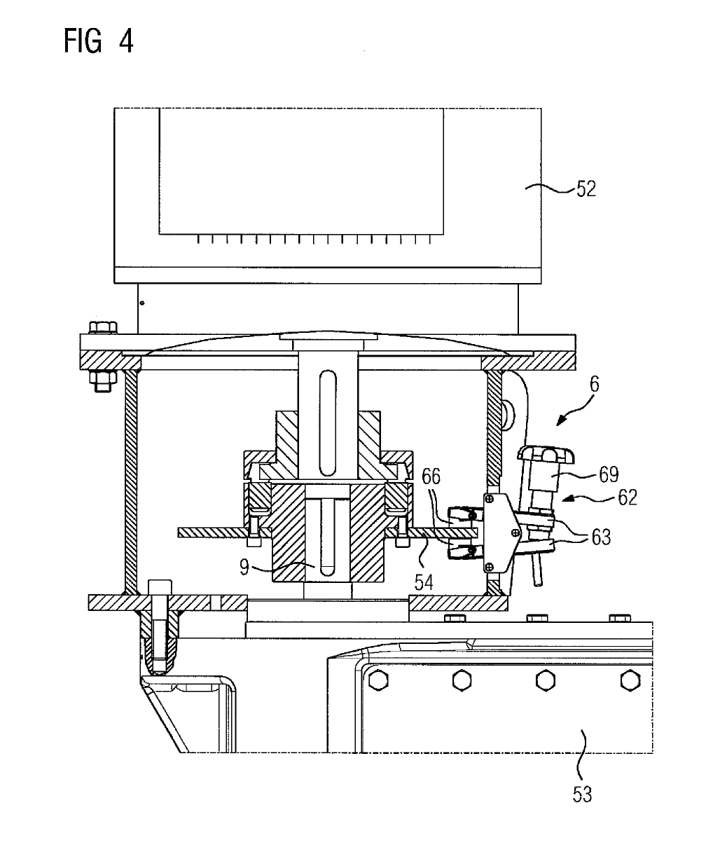

FIG. 4 shows a sectional view of a brake device;

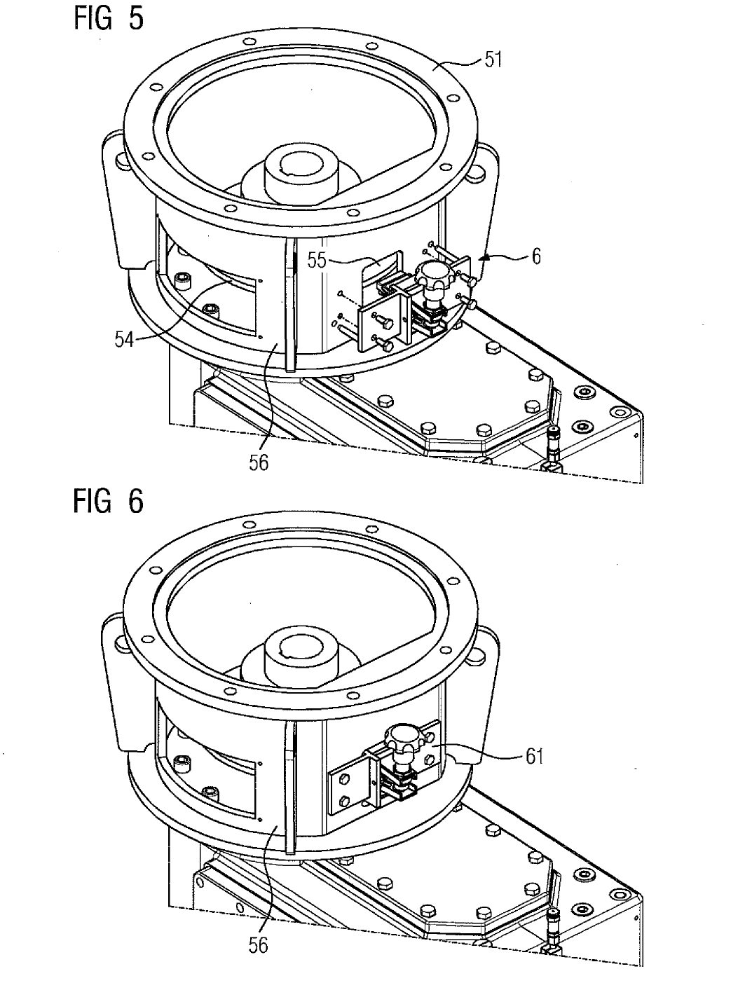

FIG. 5 shows a motor lantern;

FIG. 6 shows a mobile brake device;

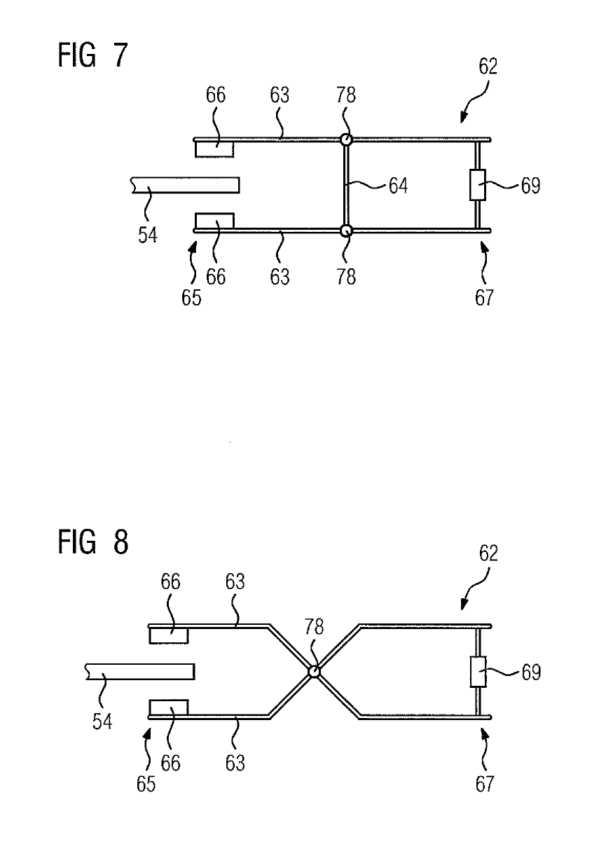

FIG. 7 shows a first operating principle of a brake caliper;

FIG. 8 shows a further operating principle of a brake caliper; and

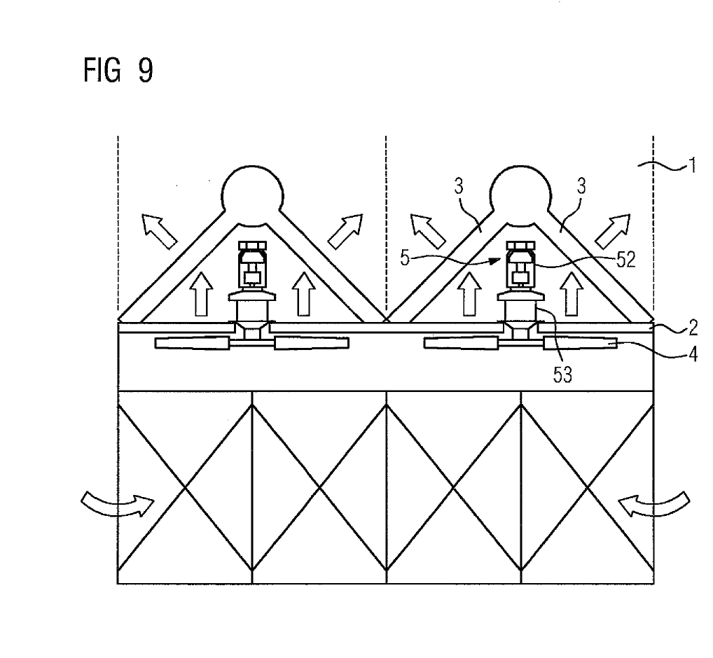

FIG. 9 shows a section through an air-cooled condenser (LUKO).

FIG. 1 shows a brake caliper 62 of a brake device 6. The caliper 62 comprises two arms 63a and 63b which are mounted in pivoted fashion in a frame 64 such that the pivot divides each of the arms 63 into a longer first section and a shorter second section. On the caliper head 65, in other words at the end of the second section of the arms 63, friction surfaces 66 are arranged on the inner surfaces of the arms 63 facing one another. On the caliper handle 67, in other words at the end of the first section of the arms 63, a thread 68 is arranged in a first arm 63a, where the thread axis runs perpendicular to the longitudinal direction of the arm 63a. A bolt 69 is screwed into the thread 68. The bolt head has a rotary knob (hand wheel) 71 which facilitates manual rotation of the bolt 69. The opposite end of the bolt 69 butts against the inner surface of the second arm 63b. When the bolt 69 is screwed into the thread 68, the arms 63 at the caliper handle move apart from one another while the arms 63 at the caliper head, and thereby the friction surfaces 66, move toward one another in a pincer movement.

The frame 64 has through-holes 70 extending at right angles to the longitudinal direction of the arms 63 for accepting threaded bolts by means of which the brake caliper 62 can be mounted on a flange.

The friction linings 66 on the caliper head are pivotably mounted; in this manner the angular position of the friction linings can be adjusted to the plane of the brake disk during the braking operation. This then also ensures that the brake linings are applied to the brake disk over their full area if the brake caliper is not positioned centrally with respect to the brake disk. The friction linings 66 are held in a home position in each case by a yoke spring (return spring) 7. The springs do however allow the linings 66 to pivot from said home position. After the brake linings 66 are released from the brake disk 54, the brake linings 66 always pivot back again into the home position on account of the spring tension of the springs 7. Any undesired rubbing of the brake linings 66 on the brake disk 54 is thereby prevented.

The maximum opening of the caliper at the caliper handle can for example be in the region of 20 to 30 mm. The maximum opening of the caliper at the caliper head, in other words the clearance between the brake linings, can for example be in the region of 15 to 30 mm. A typical brake disk has a thickness of 12 to 13 mm. Sufficient space is thus available for mounting the brake caliper, taking into consideration all the tolerances.

FIG. 2 shows in the left-hand part of the drawing a rectangular brake carrier 61, in the corner regions of which are arranged through-holes 73. The latter are provided in order to accept threaded bolts 75 which are screwed in at the side of an opening in the lantern housing 56, as illustrated in the right-hand part of the drawing. In a central region the brake carrier 61 has an opening 76 all the way through, through which the brake caliper 62 can be passed. In order to mount the brake caliper 62 on the flange 61, lugs 72 having through-holes 74 are provided at two opposite edges of the opening 76.

FIG. 3 illustrates the mounting of a mobile brake device 6 with reference to a sectional drawing. Shown in the left-hand part of the drawing is a drive unit consisting of an electric motor 52, a coupling having a brake disk 54, and a transmission 53. An output shaft 521 of the motor 52 and an input shaft 531 of the transmission 53 are connected with one another for conjoint rotation by a coupling 8, for example a claw coupling. In addition, a brake disk 54 which serves to brake the drive device and secure it to prevent rotation is arranged on the input shaft 531 of the transmission 53. The coupling 8 and the brake disk 54 are situated inside a lantern 51 which is arranged between the motor 52 and the transmission 53. The motor lantern 51 has one or two openings 55 through which the coupling and the brake disk 54 are accessible for maintenance purposes. During operation, said opening 55 is sealed off by means of a cover (not illustrated), for example in the form of a cover plate.

A mobile brake device 6 having a brake caliper 62 and a brake carrier 61 is illustrated in the right-hand part of the drawing. The brake caliper comprises two arms 63 capable of pivoting against one another, on the shorter end section of which are fitted brake linings 66. On the longer end section of the arms 63 is arranged a screw adjustment device, whereby a pincer movement of the shorter end sections of the arms 63 can be produced by turning a bolt 69 provided with a rotary handle/hand wheel 71, such that the friction linings 66 are moved toward one another. The brake caliper is arranged in an opening of the brake carrier 61 such that the longer end sections of the arms 63 are located on a first side of the brake carrier 61, the shorter end sections of the arms 63 are located on a second side of the brake carrier 61, and the pivot 78 of the brake caliper is located in the plane of the flange 61. Through-holes 73 are arranged in the corner regions of the brake carrier 61.

In order to mount the mobile brake device 6, the maintenance cover sealing off the maintenance opening 55 is firstly removed by unscrewing the bolts holding the cover from corresponding threaded holes 77 provided in the lantern housing 56. Threaded rods 75, for example in the form of stud bolts, are now screwed into said now unoccupied threaded holes 77. The brake carrier 61 is placed into position over the threaded rods 75 by pushing the through-holes 73 of the brake carrier 61 onto the threaded rods 75. It should be ensured that the brake disk 54 is arranged between the friction linings 66. Thereafter the brake carrier 61 is fixed to the lantern 51 on the threaded rods 75 by tightening nuts 79.

FIG. 4 shows a sectional view of the position of the brake device 6 resulting in this manner. The friction linings 66 of the brake caliper 62 are arranged such on both sides of the brake disk 54 that screwing the bolt 69 further in results in the friction linings 66 pressing against the brake disk 54 and thereby to a braking of the brake disk 54 and of the shaft 9 connected for conjoint rotation to the brake disk 54. The drive device consisting of motor and transmission can thus be braked and held firmly by means of the mobile brake device 6.

FIG. 5 shows a lantern 51 which is arranged between an electric motor 52 and a transmission 53. Arranged in the lantern 51 is a brake disk 54 which is connected for conjoint rotation to the input shaft of the transmission. A brake device 6 can be partially introduced into the interior of the lantern 51 through an opening 55 in a lateral surface 56 of the lantern 51.

FIG. 6 shows the brake device 6 which can be fixed by means of a brake carrier 61 to an opening of the lantern housing 56. When the brake device 6 has been mounted a first section of the brake device 6 is situated outside the lantern housing 56 of the lantern 51 and can be operated from outside while a second section of the brake device 6 is arranged inside the lantern housing 56 of the lantern 51.

The second section of the brake device 6 comprises two friction surfaces 66 which are pressed against both sides of the brake disk 54 when a hand wheel 69, which is situated in the first section of the brake device 6, is turned.

FIG. 7 shows a first operating principle of a brake caliper 62, wherein the arms 63 are pivotably mounted in each case on a frame 64 by way of a pivot 78. Opening the caliper handle 67 by means of an adjusting element 69 causes the caliper head 65 to close and thereby causes a movement toward one another of friction surfaces 66 arranged on the caliper head 65 and consequently causes braking forces to be applied evenly to both sides of a brake disk 54 positioned between the brake linings 66.

FIG. 8 shows a second operating principle of a brake caliper 62, wherein the arms 63 are pivotably mounted by way of a pivot 78. Closing the caliper handle 67 by means of an adjusting element 69 causes the caliper head 65 to close and thereby causes a movement toward one another of friction surfaces 66 arranged on the caliper head 65 and consequently causes braking forces to be applied evenly to both sides of a brake disk 54 positioned between the brake linings 66.

FIG. 9 shows a vertical section through a ventilation installation having a ventilation cell 1. Arranged in roof-like fashion above a mounting bridge 2 are heat exchangers 3 through which an air flow induced by means of a fan 4 occurs vertically from bottom to top. The fan 4 is driven by a motor-transmission combination or a geared motor 5 which comprises an electric motor 52 and a transmission 53. A mobile brake device can be flange-mounted at a position between the motor 52 and the transmission 53.

What is claimed is:

1.-7. (canceled)

8. In combination:
a transmission or geared motor having a shaft and a brake disk in fixed rotative engagement with the shaft; and
a mobile brake device detachably mounted on the transmission or the geared motor, said brake device comprising:
a brake caliper including a caliper head, at least one friction lining on the caliper head, a caliper handle, and an adjusting element on the caliper handle, said friction lining being movable by adjusting the adjusting element and capable of being pressed against the brake disk of the transmission or the geared motor when the adjusting element is actuated; and
a mounting device configured to detachably mount the brake caliper on the transmission or the geared motor.

9. The transmission or geared motor of claim 8, wherein the adjusting element is a bolt or a hydraulic cylinder.

10. The transmission or geared motor of claim 8, wherein the mounting device is a bracket.

11. A method for use of a mobile brake device including a brake caliper having a caliper head, at least one friction lining on the caliper head, a caliper handle, and an adjusting element on the caliper handle, said method comprising the steps in the order of:
detachably mounting the mobile brake device via a mounting device on a part of a fan fixed in relation to a shaft of the fan so as to position the friction lining on one side of a brake disk which is connected in fixed rotative engagement with the shaft of the fan;
adjusting the adjusting element to press the friction lining against the brake disk;
holding the brake disk and the shaft against rotation for a period of time by the brake caliper;
adjusting the adjusting element to release the friction lining from the brake disk; and
dismounting the mobile brake device from the fan via the mounting device.
